(19) United States
(12) Patent Application Publication
(10) Pub. No.: US 2022/0128180 A1
(43) Pub. Date: Apr. 28, 2022

(54) Transition Adapter

(71) Applicant: Robroy Industries - Texas, LLC, Gilmer, TX (US)

(72) Inventor: Steven A. Voelzke, Longview, TX (US)

(21) Appl. No.: 17/510,848

(22) Filed: Oct. 26, 2021

Related U.S. Application Data
(60) Provisional application No. 63/105,711, filed on Oct. 26, 2020.

(51) Int. Cl. F16L 19/02

(52) U.S. Cl. CPC F16L 19/0237; F16L 19/0218

(57) ABSTRACT

A transition adapter for a conduit system includes a body having a first end, a second end, and a hollow core. The transition adapter further includes a first threaded portion configured for connection to a conduit fitting or a cord grip fitting, a second threaded portion configured for connection to a conduit body, and a flange surface for receiving a gasket of the conduit fitting or the cord grip fitting.

### CROSS-REFERENCE TO RELATED APPLICATIONS

This application claims the benefit of U.S. Provisional Application No. 63/105,711 filed on Oct. 26, 2020 entitled “Transition Adapter”, the entirety of which is incorporated herein.

### BACKGROUND OF THE INVENTION

### Field of the Invention

The present disclosure relates generally to conduit systems. More particularly, the present disclosure relates to a transition adapter for connecting a flexible conduit fitting or cord grip fitting to a conduit body.

### Description of Related Art

Conduit is a well-known protective covering and routing path for use with electrical wire and cable in both industrial and commercial applications. Electrical installments utilizing conduit typically include lengths of conduit connected to various types of electrical boxes, conduit bodies, and conduit fittings. Conduit is offered in a variety of metal, plastic, and composite materials, and is selected based on the needs of a particular application. For example, conduit is used in a multitude of industries to form “raceways” that shield electrical wires and cables that provide power to machines, receptacles, and appliances. For examples, conduit may be used in food processing facilities, restaurants, or bar kitchens, or similar facilities. A multitude of governing bodies exist which promulgate regulations requiring that conduit used in specific applications meets certain minimum requirements.

In certain applications, it is necessary for conduit to form a seal with connected electrical boxes, conduit bodies, and/or conduit fittings to form an environmental barrier between the internal volume of the conduit and the outside environment. FIG. 1 shows an example of a conduit 10 and a conduit body 30. The conduit 10 has a threaded portion 12 which may be attached to various components, such as the conduit body 30 or an electrical box (not shown), to create a raceway through which cables can be routed. The conduit 10 may include a gasket 20 intended to create an environmental seal with the component to which the conduit 10 is attached. The gasket 20 is particularly effective when the conduit 10 is connected to an electrical box, because the flat planar surface of the electrical box acts as a seat against which the gasket 20 can compress. However, the gasket 20 may not create a satisfactory seal when connected to the conduit body 30 because conduit bodies typically lack a flat, planar surface against which the gasket 20 can compress. As a result, contamination may be allowed to enter the joint between the conduit 10 and the conduit body 30. Further, the geometry of conduit bodies 30 can vary significantly between different manufacturers, making it difficult to design a conduit 10 that would properly seal with all possible variations of conduit bodies, while still being compatible with electrical boxes.

### SUMMARY OF THE INVENTION

In view of the foregoing, there exists a need for devices and systems that can create an environmental seal between conduits and conduit bodies, and particularly for such devices and systems that are compatible with substantially all conduit bodies regardless of manufacturer-specific geometry.

Embodiments of the present invention are directed to a transition adapter for a conduit system. The transition adapter includes a body having a first end, a second end, and a hollow core. The transition adapter further includes a first threaded portion configured for connection to a conduit fitting or a cord grip fitting, a second threaded portion configured for connection to a conduit body mimicking a rigid conduit connection, and a flange surface for receiving a gasket of the conduit fitting or the cord grip fitting.

In some embodiments, the flange surface is offset from an end face of the first end.

In some embodiments, the first end of the body includes a cylindrical portion.

In some embodiments, the body includes a tapered portion extending between the first end and the second end.

In some embodiments, the tapered portion includes a linear taper, a radius, or a curved profile.

In some embodiments, the transition adapter further includes a plurality of gripping features disposed about the body configured to receive a tool.

In some embodiments, the transition adapter further includes a circumferential sealing surface for receiving one or more seals of the conduit body.

In some embodiments, the first threaded portion includes a female thread.

In some embodiments, the second threaded portion includes a male thread.

In some embodiments, the transition adapter further includes a flared end adjacent to an end face of the first end.

Other embodiments of the present invention are directed to a conduit system including a conduit including a rigid or flexible tube, a conduit fitting connected to the tube and having a threaded end, a gasket disposed on the conduit fitting. The system further includes a conduit body including a threaded port. The system further includes a transition adapter including a body having a first end, a second end, and a hollow core. The transition adapter further includes a first threaded portion receiving the threaded end of the conduit, a second threaded portion received by the threaded port of the conduit body, and a flange surface for receiving the gasket of the conduit fitting.

In some embodiments, the gasket is compressed between the flange surface of the transition adapter and the threaded end of the conduit fitting.

In some embodiments, the tube of the conduit is rigid.

In some embodiments, the conduit body includes one or more seals, and the transition adapter includes one or more circumferential engagement surfaces receiving the one or more seals.

In some embodiments, the one or more seals is compressed against the circumferential engagement surface.

In some embodiments, the flange surface is offset from an end face of the body of the transition adapter.

In some embodiments, the body of the transition adapter includes a tapered portion extending between the first end and the second end.

In some embodiments, the first threaded portion of the transition adapter includes a female thread.

In some embodiments, the second threaded portion of the transition adapter includes a male thread.

Other embodiments of the present invention are directed to a conduit system including a cord and a cord fitting connected to the cord. The cord fitting includes a threaded end and a gasket disposed on the threaded end. The system further includes a conduit body including a threaded port. The system further includes a transition adapter including a body having a first end, a second end, and a hollow core. The transition adapter further includes a first threaded portion receiving the threaded end of the cord fitting, a second threaded portion received by the threaded port of the conduit body, and a flange surface for receiving the gasket of the cord fitting.

These and other features and characteristics of a transition adapter, a conduit system, and associated methods of use will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and the claims, the singular forms of “a”, “an”, and “the” include plural referents unless the context clearly dictates otherwise.

### BRIEF DESCRIPTION OF THE DRAWINGS

FIG. 1 is a side cross-sectional view of a prior art conduit and conduit body;

FIG. 2 is a side view of a conduit system in accordance with an embodiment of the present invention;

FIG. 3 is a side view of a transition adapter according to an embodiment of the present invention;

FIG. 4 is a side cross-sectional view of the transition adapter of FIG. 3;

FIG. 5 is a cross-sectional view along line A-A of FIG. 2;

FIG. 6 is a side view of a conduit system in accordance with an embodiment of the present invention;

FIG. 7 is a cross-sectional view along line B-B of FIG. 6; and

FIG. 8 is a bottom perspective view of the conduit system of FIG. 6, with the cord removed for clarity.

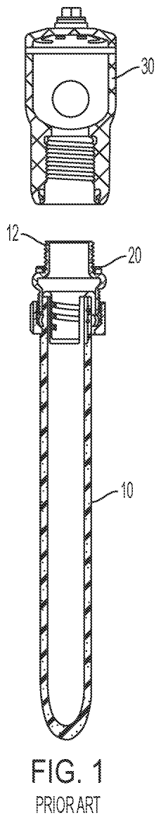

### DESCRIPTION OF THE INVENTION

For purposes of the description hereinafter, the terms “upper”, “lower”, “right”, “left”, “vertical”, “horizontal”, “top”, “bottom”, “lateral”, “longitudinal”, and derivatives thereof shall relate to the disclosure as it is oriented in the figures. However, it is to be understood that the disclosure may assume alternative variations and step sequences, except where expressly specified to the contrary. It is also to be understood that the specific devices and processes illustrated in the attached drawings and described in the following specification are simply exemplary aspects of the disclosure. Hence, specific dimensions and other physical characteristics related to the aspects disclosed herein are not to be considered as limiting.

As used herein, the term “at least one of” is synonymous with “one or more of”. For example, the phrase “at least one of A, B, and C” means any one of A, B, and C, or any combination of any two or more of A, B, and C. For example, “at least one of A, B, and C” includes one or more of A alone; or one or more of B alone; or one or more of C alone; or one or more of A and one or more of B; or one or more of A and one or more of C; or one or more of B and one or more of C; or one or more of all of A, B, and C. Similarly, as used herein, the term “at least two of” is synonymous with “two or more of”. For example, the phrase “at least two of D, E, and F” means any combination of any two or more of D, E, and F. For example, “at least two of D, E, and F” includes one or more of D and one or more of E; or one or more of D and one or more of F; or one or more of E and one or more of F; or one or more of all of D, E, and F.

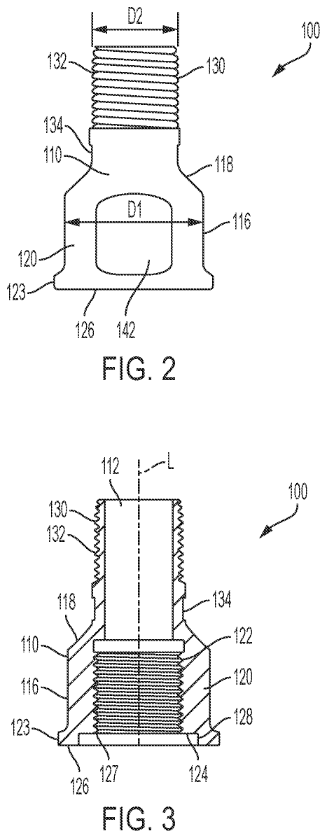

Referring now to FIGS. 2-5, embodiments of the present invention are directed to a transition adapter 100 for use in a conduit system 1000. The transition adapter 100 is configured to connect a conduit 200 to a conduit body 300. The conduit 200 is generally flexible conduit, though in some embodiments the conduit 200 may be rigid. The transition adapter 100 includes a body 110 having a first end 120 configured for connection to a conduit fitting 210 attached to the conduit 200 and a second end 130 configured for connection to the conduit body 300. When installed in a system including the conduit 200, the conduit fitting 210 and the conduit body 300, the transition adapter 100 creates an environmental seal between the conduit 200 and the conduit body 300 that prevents contaminants in the outside atmosphere from entering into the conduit 200 and/or the conduit body 300.

The body 110 of the transition adapter 100 may define a hollow core 112 extending along a longitudinal axis L of the body 110. The hollow core 112 may be sized to allow wire and cable to be routed through the transition adapter 100 from the conduit 200 to the conduit body 300.

The body 110 of the transition adapter 100 may be formed of a rigid material such as carbon steel, stainless steel, aluminum, other metals, plastics, composites, or the like. The body 110 may be coated to provide corrosion resistance, sterility, or other desirable properties.

The first end 120 of the transition adapter 100 may include a first threaded portion 122 having a thread profile corresponding to a threaded end 211 of the conduit fitting 210. For example, the first threaded portion 122 may be a female thread if the threaded end 211 of the conduit fitting 210 is a male thread. Similarly, the second end 130 of the transition adapter 100 includes a second threaded portion 132 having a thread profile corresponding to a threaded port 310 of the conduit body 300. For example, the second threaded portion 132 may be a male thread if the threaded port 310 of the conduit body 300 is a female thread.

The first threaded portion 122 and the second threaded portion 132 of the transition adapter 100 may be straight threads or tapered threads according to various industry standards, such as National Pipe Thread (NPT). In the embodiments shown in the accompanying drawings, the first threaded portion 122 and the second threaded portion 132 of the transition adapter 100 have threads of the same nominal dimension for connecting conduit and conduit bodies of the same nominal size. For example, the first threaded portion 122 and the second threaded portion 132 have ¾ inch NPT threads for connecting such that the transition adapter 1000 could be used to connect a ¾ inch nominal conduit to a ¾ inch nominal conduit body. However, in other embodiments, the first threaded portion 122 and the second threaded portion 132 may have threads of different nominal dimensions such that the transition adapter 1000 can function as a reducer. For example, the first threaded portion 122 may have ¾ inch NPT threads while the second threaded portion 132 has 1 inch NPT threads such that the transition adapter 1000 could be used to connect a ¾ inch nominal conduit to a 1 inch nominal conduit body.

With continued reference to FIGS. 2-5, the first end 120 of the transition adapter 100 may include a cylindrical portion 116 in which the first threaded portion 122 is defined. The cylindrical portion 116 may have an outer diameter Dl greater than an outer diameter D2 of the second end 130. A tapered portion 118 may extend from the cylindrical portion 116 toward the second end 130 to decrease the outer diameter of the body 110 from the first end 120 to the second end 130. The tapered section 118 may have a linear taper, a radius, or a curved profile. In other embodiments, the tapered section 118 may be replaced with a step or shoulder. The first end 120 of the transition adapter 100 may further include a flared end 123 adjacent to an end face 126 of the first end 120. The flared end 123 may increase the diameter of the end face 126 to improve the seal between the transition adapter 100 and the conduit fitting 210. The flared end 123 may have a tapered or curved profile.

A plurality of wrench flats 142 or other gripping features may be disposed about the circumference of the body 110, such as on the cylindrical portion 116, configured to receive a tool for installing the transition adapter 100.

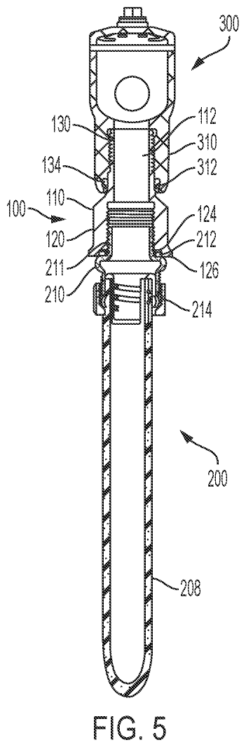

The second end 130 of the body 110 may include a circumferential sealing surface 134 configured to engage one or more seals 312, such as O-rings, of the conduit body 300 (see FIG. 5) to establish an environmental barrier between the transition adapter 100 and the conduit body 300. The circumferential sealing surface 134 may have an outer diameter less than an inner diameter of the one or more seals 312 such that the one or more seals or O-rings 312 compresses against the circumferential sealing surface 134. In some embodiments, the circumferential sealing surface 134 may be recessed into the body 110 in the form of a groove or channel in which the one or more seals 312 of the conduit body 300 may rest. In other embodiments, the conduit body 300 may lack the one or more seals 312, but an environmental barrier may still be established between the transition adapter 100 and the conduit body 300 by the engagement of the second threaded portion 132 of the transition fitting 100 to the threaded port 310 of the conduit body 300.

With particular reference to FIG. 3, the first end 120 of the transition adapter 100 may include a flange surface 124 extending perpendicular to the longitudinal axis L of the body 110. The flange surface 124 serves as a seat which receives a gasket 212 of the conduit fitting 210 when the transition adapter 100 is connected to the conduit 200. During assembly of the transition adapter 100 to the conduit 200, the gasket 212 is compressed against the flange surface 124 as the threaded end 211 of the conduit fitting 210 of the conduit 200 is threaded into the first threaded portion 122 of the transition adapter 100. The gasket 212 creates an environmental seal between the transition adapter 100 and the conduit 200. The flange surface 124 may be recessed in the first end 120 of the transition adapter 100 such that the flange surface 124 is offset from the end face 126 of the first end 120 by a step 128.

With continued reference to FIG. 3, the first end 120 of the transition adapter 100 may include an internal annular surface 127 extending longitudinally from the flange surface 124. The annular surface 127 may mimic the thickness of a wall of an electrical enclosure such that various fittings, connectors, etc. designed to interface with an electrical enclosure are also able to interface with the transition adapter 100.

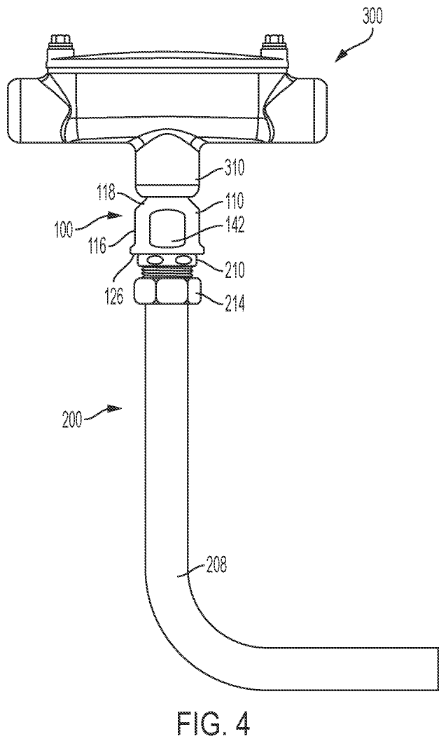

With particular reference to FIGS. 4-5, embodiments of the present invention are directed to a conduit system 1000 including the transition adapter 100, the conduit 200, and the conduit body 300. The threaded end 211 of the conduit fitting 210 may be connected to a tube 208 of the conduit 200 via a compression fitting 214. The tube 208 of the conduit may be rigid or flexible. The threaded end 211 of the conduit fitting 210 may be threaded into the first threaded portion 122 of the transition adapter 100 until the gasket 210 of the conduit fitting 210 is compressed against the flange surface 124 of the transition adapter 100. The compressed gasket 210 creates a environmental barrier that prevents materials such as solids, liquids, and/or gases from passing through the joint between the transition adapter 100 and the conduit 200.

The second threaded portion 132 of the transition adapter 100 may be threaded into the threaded port 310 of the conduit body 300 until the one or more seals 312 of the conduit body 300 is aligned with and compressed against the circumferential sealing surface 134. The compressed one or more seals 312 creates a environmental barrier that prevents materials such as solids, liquids, and/or gases from passing through the joint between the transition adapter 100 and the conduit body 300. In embodiments in which the conduit body 300 lacks the one or more seals 312, the second threaded portion 132 of the transition adapter 100 may be threaded into the threaded port 310 of the conduit body 300 until the environmental barrier is created due to engagement of the threaded portion 132 and the threaded port 310. The connection between the second threaded portion 132 of the transition adapter 100 and the conduit body 300 mimics the connection provided by conventional rigid conduit.

The assembled conduit system 1000 forms a raceway such that wire and cable (not shown) can be routed from the conduit 200 to the conduit body 300, and vice versa, via the hollow core 122 of the transition adapter 100.

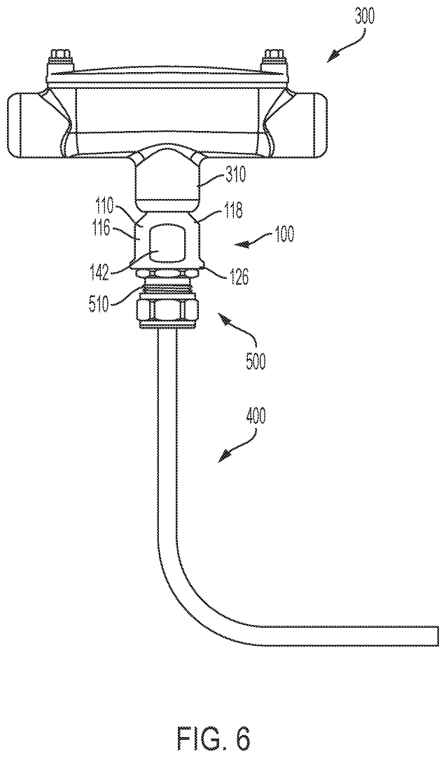

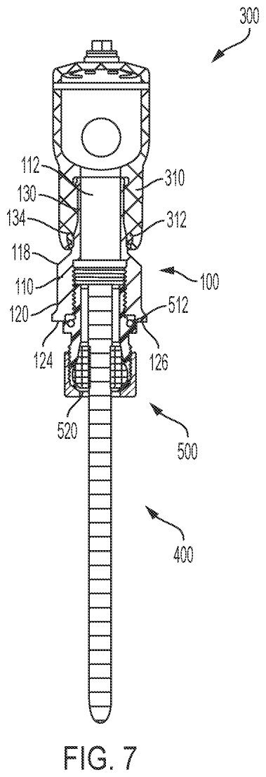

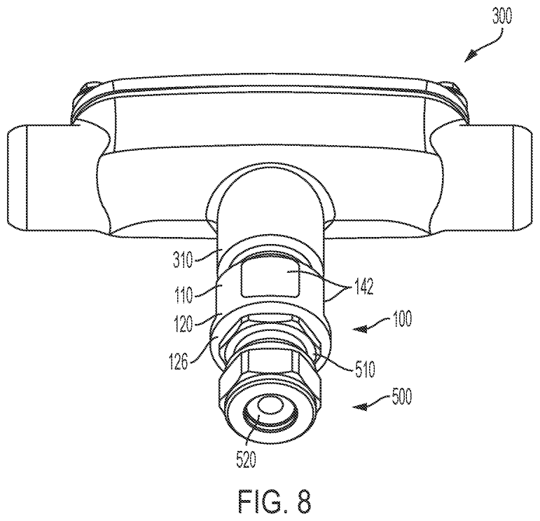

Referring now to FIGS. 6-8, other embodiments of the present invention are directed to a conduit system 1000 including the transition adapter 100, the conduit body 300, a cord 400, and a cord grip fitting 500. The transition adapter 100 in the embodiments shown in FIGS. 6-8, may be identical to the transition adapter of FIGS. 2-5. The cord grip fitting 500 may include a threaded end 510 configured to be threaded into the first threaded portion 122 of the transition adapter 100. The cord grip fitting 500 may include a gasket 512 which is similar or identical to the gasket 210 of the conduit fitting 210 of the embodiment of FIGS. 4-5. The gasket 512 may compress against the flange surface 124 of the transition adapter 100 to form an environmental barrier that prevents materials such as solids, liquids, and/or gases from passing through the joint between the transition adapter 100 and the cord fitting 500. The cord grip fitting 500 may be connected to the cord 400 and may include a seal 520 to create a environmental barrier between the cord grip fitting 500 and the cord 400.

With continued reference to FIGS. 6-8, the second threaded portion 132 of the transition adapter 100 may be threaded into the threaded port 310 of the conduit body 300 in the same manner described herein in connection with FIGS. 4-5. The cord 400, or various wires and/or cables contained within the cord 400, may be routed through the hollow core 122 of the transition adapter 100 to the conduit body 300.

While various embodiments of a transition adapter, a conduit system, and associated methods of use were provided in the foregoing description, those skilled in the art may make modifications and alterations to these aspects without departing from the scope and spirit of the invention. For example, it is to be understood that this disclosure contemplates that, to the extent possible, one or more features of any aspect can be combined with one or more features of any other aspect. Accordingly, the foregoing description is intended to be illustrative rather than restrictive. The invention described hereinabove is defined by the appended claims, and all changes to the invention that fall within the meaning and the range of equivalency of the claims are to be embraced within their scope.

1. A transition adapter for a conduit system, the transition adapter comprising:
a body having a first end, a second end, and a hollow core;
a first threaded portion configured for connection to a conduit fitting or a cord fitting;
a second threaded portion configured for connection to a conduit body; and
a flange surface for receiving a gasket of the conduit fitting or the cord fitting.

2. The transition adapter of claim 1, wherein the flange surface is offset from an end face of the first end.

3. The transition adapter of claim 1, wherein the first end of the body includes a cylindrical portion.

4. The transition adapter of claim 1, wherein the body comprises a tapered portion extending between the first end and the second end.

5. The transition adapter of claim 4, wherein the tapered portion includes a linear taper, a radius, or a curved profile.

6. The transition adapter of claim 1, further comprising a plurality of gripping features disposed about the body configured to receive a tool.

7. The transition adapter of claim 1, further comprising a circumferential sealing surface for receiving one or more seals of the conduit body.

8. The transition adapter of claim 1, wherein the first threaded portion comprises a female thread.

9. The transition adapter of claim 1, wherein the second threaded portion comprises a male thread.

10. The transition adapter of claim 1, further comprising a flared end adjacent to an end face of the first end.

11. A conduit system comprising:
a conduit comprising:
a rigid or flexible tube;
a conduit fitting connected to the tube and having a threaded end;
a gasket disposed on the conduit fitting;
a conduit body comprising a threaded port; and
a transition adapter comprising:
a body having a first end, a second end, and a hollow core;
a first threaded portion receiving the threaded end of the conduit fitting;
a second threaded portion received by the threaded port of the conduit body; and
a flange surface for receiving the gasket of the conduit fitting.

12. The conduit system of claim 11, wherein the gasket is compressed between the flange surface of the transition adapter and the threaded end of the conduit fitting.

13. The conduit system of claim 11, wherein the tube of the conduit is flexible or rigid.

14. The conduit system of claim 11, wherein the conduit body comprises one or more seals, and
wherein the transition adapter comprises one or more circumferential engagement surfaces receiving the one or more seals.

15. The conduit system of claim 14, wherein the one or more seals is compressed against the circumferential engagement surface.

16. The conduit system of claim 11, wherein the flange surface is offset from an end face of the body of the transition adapter.

17. The conduit system of claim 11, wherein the body of the transition adapter comprises a tapered portion extending between the first end and the second end.

18. The conduit system of claim 11, wherein the first threaded portion of the transition adapter comprises a female thread.

19. The conduit system of claim 11, wherein the second threaded portion of the transition adapter comprises a male thread.

20. A conduit system comprising:
a cord;
a cord fitting connected to the cord and comprising:
a threaded end; and
a gasket disposed on the threaded end;
a conduit body comprising a threaded port; and
a transition adapter comprising:
a body having a first end, a second end, and a hollow core;
a first threaded portion receiving the threaded end of the cord fitting;
a second threaded portion received by the threaded port of the conduit body; and
a flange surface for receiving the gasket of the cord fitting.
